(19) United States
(12) Patent Application Publication
(10) Pub. No.: US 2011/0170232 A1
(43) Pub. Date: Jul. 14, 2011

(54) ELECTRICAL ENERGY STORAGE UNIT AND METHODS FOR FORMING SAME

(75) Inventors: Richard D. Weir, Cedar Park, TX (US); Carl W. Nelson, Cedar Park, TX (US)

(73) Assignee: EESTOR, INC., Cedar Park, TX (US)

(21) Appl. No.: 12/245,461

(22) Filed: Oct. 3, 2008

Related U.S. Application Data
(63) Continuation-in-part of application No. 10/917,144, filed on Aug. 13, 2004, now Pat. No. 7,466,536.

(51) Int. Cl. H01G 4/06

(52) U.S. Cl. 361/312; 29/25.42

(57) ABSTRACT

An electrical storage unit includes a plurality of sets of layers. Each set of layers includes a first layer, a second layer, a third layer, and a fourth layer. The first layer includes a first electrode and plastic surrounding the first electrode on three sides of the first electrode within the first layer. The second layer includes a first active dielectric and plastic surrounding the first active dielectric on all four sides of the first active dielectric within the second layer. The third layer includes a second electrode and plastic surrounding the second electrode on three sides of the second electrode within the third layer. The fourth layer includes a second active dielectric and plastic surrounding the second active dielectric on all four sides of the second active dielectric within the fourth layer.

### CROSS-REFERENCE TO RELATED APPLICATION(S)

The present application is a continuation-in-part application of U.S. patent application Ser. No. 10/917,144, filed Aug. 13, 2004, entitled “UTILIZATION OF POLY(ETHYLENE TEREPHTHALATE) PLASTIC AND COMPOSITION-MODIFIED BARIUM TITANATE POWDERS IN A MATRIX THAT ALLOWS POLARIZATION AND THE USE OF INTEGRATED-CIRCUIT TECHNOLOGIES FOR THE PRODUCTION OF LIGHTWEIGHT ULTRAHIGH ELECTRICAL ENERGY STORAGE UNITS (EESU),” naming inventors Richard D. Weir and Carl W. Nelson, which application is incorporated by reference herein in its entirety

### FIELD OF THE DISCLOSURE

This invention relates generally to energy-storage devices, and relates more particularly to polarized high-permittivity ceramic powders immersed into a plastic matrix that has been used to fabricate components that are utilized in an array configuration for application in ultrahigh-electrical-energy storage devices.

### BACKGROUND

The internal-combustion-engine (ICE) powered vehicles have as their electrical energy sources a generator and battery system. This electrical system powers the vehicle accessories, which include the radio, lights, heating, and air conditioning. The generator is driven by a belt and pulley system and some of its power is also used to recharge the battery when the ICE is in operation. The battery initially provides the required electrical power to operate an electrical motor that is used to turn the ICE during the starting operation and the ignition system. The most common batteries in use today are flooded lead-acid, sealed gel lead-acid, Nickel-Cadmium (Ni-Cad), Nickel Metal Hydride (NiMH), and Nickel-Zinc (Ni—Z). References on the subject of electrochemical batteries include the following: Guardian, Inc., “Product Specification”; K. A. Nishimura, “NiCd Battery”, Science Electronics FAQ V1.00: Nov. 20, 1996; Ovonics, Inc., “Product Data Sheet”: no date; Evercel, Inc., “Battery Data Sheet—Model 100”: no date; D. Corrigan, I. Menjak, B. Cleto, S. Dhar, S. Ovshinsky, Ovonic Battery Company, Troy, Mich., USA, “Nickel-Metal Hydride Batteries For ZEV-Range Hybrid Electric Vehicles”; B. Dickinson et al., “Issues and Benefits with Fast Charging Industrial Batteries”, AeroVeronment, Inc. article: no date.

Each specific type of battery has characteristics, which make it either more or less desirable to use in a specific application. Cost is always a major factor and the NiMH battery tops the list in price with the flooded lead-acid battery being the most inexpensive. Evercel manufactures the Ni—Z battery and by a patented process, with the claim to have the highest power-per-pound ratio of any battery. See Table 1 below for comparisons among the various batteries. What is lost in the cost translation is the fact that NiMH batteries yield nearly twice the performance (energy density per weight of the battery) than do conventional lead-acid batteries. A major drawback to the NiMH battery is the very high self-discharge rate of approximately 5 to 10% per day. This would make the battery useless in a few weeks. The Ni-Cad battery, as does the lead-acid battery, also have self-discharge, but it is in the range of about 1% per day. Both contain hazardous materials such as acid or highly toxic cadmium. The Ni—Z and the NiMH batteries contain potassium hydroxide and this electrolyte in moderate and high concentrations is very caustic and will cause severe burns to tissue and corrosion to many metals such as beryllium, magnesium, aluminum, zinc, and tin.

Another factor that must be considered when making a battery comparison is the recharge time. Lead-acid batteries require a very long recharge period, as long as 6 to 8 hours. Lead-acid batteries, because of their chemical makeup, cannot sustain high current or voltage continuously during charging. The lead plates within the battery heat rapidly and cool very slowly. Too much heat results in a condition known as “gassing” where hydrogen and oxygen gases are released from the battery's vent cap. Over time, gassing reduces the effectiveness of the battery and also increases the need for battery maintenance, i.e., requiring periodic deionized or distilled water addition. Batteries such as Ni-Cad and NiMH are not as susceptible to heat and can be recharged in less time, allowing for high current or voltage changes which can bring the battery from a 20% state of charge to an 80% state of charge in as quickly as 20 minutes. The time to fully recharge these batteries can take longer than an hour. Common to all present day batteries is a finite life and if they are fully discharged and recharged on a regular basis their life is reduced considerably.

### SUMMARY

In a particular embodiment, an electrical storage unit includes a plurality of sets of layers. Each set of layers includes a first layer, a second layer, a third layer, and a fourth layer. The first layer includes a first electrode and plastic surrounding the first electrode on three sides of the first electrode within the first layer. The second layer includes a first active dielectric and plastic surrounding the first active dielectric on all four sides of the first active dielectric within the second layer. The third layer includes a second electrode and plastic surrounding the second electrode on three sides of the second electrode within the third layer. The fourth layer includes a second active dielectric and plastic surrounding the second active dielectric on all four sides of the second active dielectric within the fourth layer.

In a further exemplary embodiment, an electrical storage unit includes a plurality of sets of layers. Each set of layers includes a first layer, a second layer, a third layer, and a fourth layer. The first layer includes a first electrode and plastic surrounding the first electrode on three sides of the first electrode within the first layer. The first electrode is offset to one end of the first layer. The second layer includes a first active dielectric and plastic surrounding the first active dielectric on all four sides of the first active dielectric within the second layer. The third layer includes a second electrode and plastic surrounding the second electrode on three sides of the second electrode within the third layer. The second electrode is offset to an opposite end relative to the one end. The fourth layer includes a second active dielectric and plastic surrounding the second active dielectric on all four sides of the second active dielectric within the fourth layer. The first electrodes of the repeated sets of layers are connected to one another. The second electrodes of the repeated sets of layers are connected to one another. The first and second active dielectrics are polarized.

In an additional embodiment, a method of forming an electrical energy storage unit includes (a) printing plastic as part of a first layer; (b) printing, onto the first layer, a second layer including metal to serve as a first electrode; (c) printing, surrounding on three sides of the first electrode, plastic as part of the second layer; (d) printing, onto the second layer and as part of a third layer, an active dielectric layer including plastic and a ceramic powder; (e) printing plastic as part of the third layer and surrounding the active dielectric layer on four sides; (f) printing, onto the third layer, a fourth layer including metal to serve as a second electrode; and (g) printing plastic as part of the fourth layer and surrounding the second electrode on three sides.

### BRIEF DESCRIPTION OF THE DRAWINGS

The present disclosure may be better understood, and its numerous features and advantages made apparent to those skilled in the art by referencing the accompanying drawings.

FIG. 1 indicates a schematic of 31,351 energy storage components 9 hooked up in parallel with a total capacitance of 30.693 F. The maximum charge voltage 8 of 3500 V is indicated with the cathode end of the energy storage components 9 hooked to system ground 10.

FIG. 2 is a cross-section side view of the electrical-energy-storage unit component. This figure indicates the alternating layers of aluminum electrode layers 12 and high-permittivity composition-modified barium titanate dielectric in a poly(ethylene terephthalate) plastic matrix developed into layers 11. This figure also indicates the alternately offset aluminum electrode layers 12 so that each storage layer is connected in parallel.

FIG. 3 is side view of a single-layer array indicating the attachment of individual components 15 with the aluminum end caps attached by silver-filled epoxy resin 14 attached to two opposite polarity copper conducting sheets 13.

FIG. 4 is a side view of a double-layer array with copper array connecting aluminum end caps bonded with silver-filled epoxy resin 16 and then attaching the two arrays via the edges of the opposite polarity copper conductor sheets 13. This figure indicates the method of attaching the components in a multilayer array to provide the energy storage.

All of the data indicated in the drawings can be either lower or higher depending of the number of samples, test configurations, environmental conditions, and calibration status of the test equipment. The use of the same reference symbols in different drawings indicates similar or identical items.

### REFERENCE NUMERALS IN DRAWINGS

| | |
|---|---|
| 8 | System voltage of 3500 V |
| 9 | 31,351 energy-storage components hooked up in parallel with a |
| | total capacitance of 30.693 F |
| 10 | System ground |
| 11 | High-permittivity calcined alumina-coated composition-modified |
| | barium titanate powder dispersed in poly(ethylene terephthalate) |
| | plastic matrix dielectric layers |
| 12 | Alternately offset aluminum electrode layers |
| 13 | Copper conductor sheets |
| 14 | Aluminum end caps |
| 15 | Components |
| 16 | Copper array connecting aluminum end caps |

The indicated voltages, number of components, capacitance values, and materials can be changed for different applications.

### DESCRIPTION OF THE PREFERRED EMBODIMENT(S)

In accordance with the illustrated preferred embodiment, the present invention provides a unique lightweight electrical-energy-storage unit that has the capability to store ultrahigh amounts of energy.

The basis material, an aluminum oxide coated high-permittivity calcined composition-modified barium titanate powder which is a ceramic powder described in the following references: S. A. Bruno, D. K. Swanson, and I. Burn, J. Am. Ceram. Soc. 76, 1233 (1993); P. Hansen, U.S. Pat. No. 6,078,494, issued Jun. 20, 2000, and U.S. patent application Ser. No. 09/833,609, is used as the energy storage material for the fabrication of the electrical energy storage units (EESU).

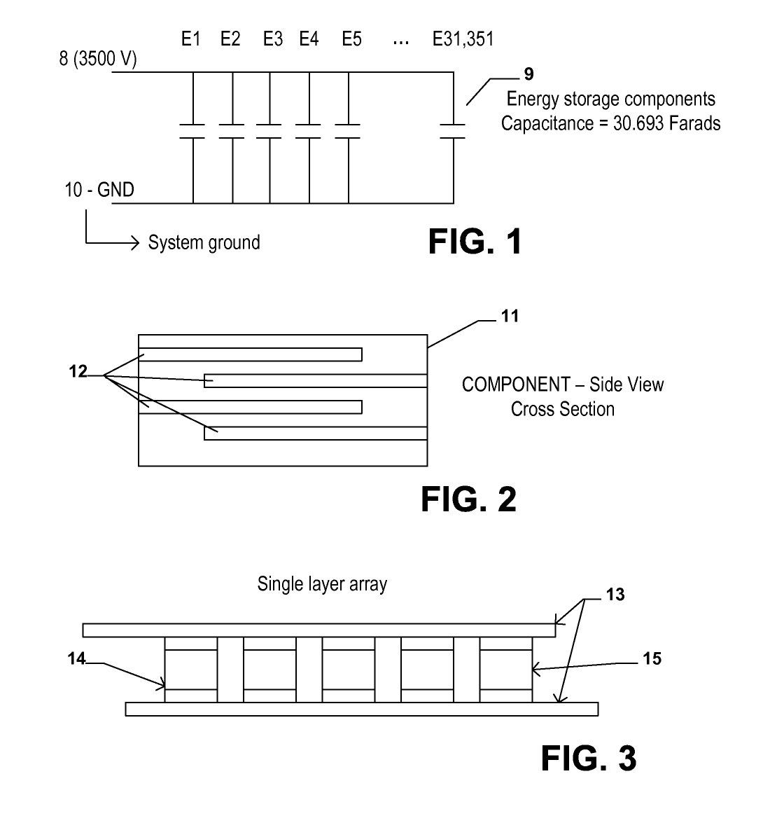

Yet another aspect of the present invention is that the alumina-coated calcined composition-modified barium titanate (alumina-coated calcined CMBT) powder and the immersion of these powders into a poly(ethylene terephthalate) plastic matrix provides many enhancement features and manufacturing capabilities to the basis material. The alumina-coated calcined CMBT powder and the poly(ethylene terephthalate) plastic have exceptional high-voltage breakdown, and when used as a composite with the plastic as the matrix, the average voltage breakdown was 5.57×10⁶ V/cm or higher. The voltage breakdown of the poly(ethylene terephthalate) plastic is rated at 580 V/μm at 23° C. and the voltage breakdown of the alumina-coated CMBT powders is 610 V/μm at 85° C. These voltage breakdown ratings can be lower or higher than these indicated values. The following reference indicates the dielectric breakdown strength in V/cm of composition-modified barium titanate materials: J. Kuwata et al., “Electrical Properties of Perovskite-Type Oxide Thin-Films Prepared by R F Sputtering”, Jpn. J. Appl. Phys., Part 1, 1985, 24 (Suppl. 24-2, Proc. Int. Meet. Ferroelectr., 6th), 413-15. The following reference indicates the dielectric breakdown strength in V/μm of poly(ethylene terephthalate) materials: Mitsubishi Polyester Film corporation specification sheet for ®Hostaphan RE film for capacitors, Edition November 3. This very-high-voltage breakdown assists in allowing the ceramic EESU to store a large amount of energy due to the following: Stored energy E=CV²/2, Formula I, as indicated in F. Sears et al., “Capacitance—Properties of Dielectrics”, University Physics, Addison-Wesley Publishing Company, Inc.: December 1957: pp 468-486, where C is the capacitance, V is the voltage across the EESU terminals, and E is the stored energy. This indicates that the energy of the EESU increases with the square of the voltage. FIG. 1 indicates that a double array of 31,351 energy storage components 9 in a parallel configuration that contains the alumina-coated calcined composition-modified barium titanate powder. Fully densified ceramic components of this powder coated with approximately 100 Å of aluminum oxide (alumina) 8 and approximately a 100 Å of poly(ethylene terephthalate) plastic as the matrix 8 with a dielectric thickness of approximately 9.732 μm can be safely charged to 3500 V. The number of components in the double array depends on the electrical energy storage requirements of the application. The number of components in the array can vary from 2 to 10,000 or more. The total number of components in the arrays for the example is 31,351. The total capacitance of these particular arrays 9 is approximately 30.693 F, which allows in the area of 52,220 W·h of energy to be stored as derived by Formula 1.

The alumina-coated calcined CMBT powder and the poly(ethylene terephthalate) plastic matrix also assist in significantly lowering the leakage and aging of ceramic components comprising the calcined composition-modified barium titanate powder to a point where they do not affect the performance of the EESU. In fact, the discharge rate of the EESU is lower than approximately 0.1% per 30 days, which is in the area of approximately an order of magnitude lower than the best electrochemical battery.

A significant advantage of the present invention is that the PET plastic matrix assists in lowering the sintering temperature to approximately 150° C., hot-isostatic-pressing temperatures to approximately 180° C., and the pressure to in the area of 100 bar. These lower temperatures eliminate the need to use very expensive platinum, palladium, palladium-silver alloy, or less expensive but still costly nickel powders as the terminal metal. In fact, these temperatures are in a safe range that allows aluminum, the fourth best conductor, to be used for the electrodes, providing a major cost saving in material expense and also power usage during the hot-isostatic-pressing process. Aluminum as a metal is not hazardous. The lower pressure provides low processing cost for the hot-isostatic-pressing step. Also, since the PET plastic becomes easily deformable and flowable at these temperatures, voids are readily removed from the components during the hot-isostatic-pressing process. A manufacturer of such hot-isostatic-pressing ovens is Material Research Furnances Inc. For the EESU product to be successful, voids are to be eliminated so that the high-voltage breakdown can be obtained. Also, the method described here of using the poly(ethylene terephthalate) plastic as the matrix for the high-relativity-permittivity alumina-coated composition-modified barium titanate powder ensures the hot-isostatic-pressing results in layers that are uniform homogeneous and substantially void free.

None of the EESU materials used to fabricate the EESU, which are aluminum, aluminum oxide, copper, composition-modified barium titanate powder, silver-filled epoxy, and poly(ethylene terephthalate) plastic explode when being recharged or impacted. Thus, the EESU is a safe product when used in electric vehicles, buses, bicycles, tractors, or any device that is used for transportation or to perform work, portable tools of all kinds, portable computers, or any device or system that requires electrical energy storage. It could also be used for storing electrical power generated from electrical energy generating plants, solar voltaic cells, wind-powered electrical energy generating units, or other alternative sources on the utility grids of the world for residential, commercial, or industrial applications. The power averaging capability of banks of EESU devices with the associated input/output converters and control circuits provide significant improvement of the utilization of the power generating plants and transmission lines on the utility grids of the world. The EESU devices along with input/output converters and control circuits may also provide power averaging for all forms of alternative energy producing technology, but specifically wind and solar may have the capability to provide constant electrical power due to the EESU storing sufficient electrical energy that can meet the energy requirements of residential, commercial, and industrial sites. In fact, wind could become a major source of electrical energy due to the capability of the EESU technology to convert wind from a peak provider, i.e., when the wind blows and power is needed it is used, to a cost-effective primary electrical energy supplier, such as are coal-fired plants.

Yet another aspect of the present invention is that each component of the EESU can be produced by screen-printing multiple layers of aluminum electrodes with screening ink from aluminum powder. Interleaved between aluminum electrodes are dielectric layers formed with screening ink from calcined alumina-coated high-permittivity composition-modified barium titanate powder immersed in poly(ethylene terephthalate) plastic as the matrix. A unique independent dual screen-printing and layer-drying system can be used for this procedure. However the printing of the components could also be accomplished by utilizing a high temperature/pressure mini extrusion multilayering technique which has the capability of providing in situ drying, binder-burnout, and sintering operations. Alternatively, other printing techniques may be used, for example, continuous printing techniques, ink jet printing techniques, or other printing techniques, or any combination of the above. While the examples below describe screen-printing, other printing techniques may be used instead of or in conjunction with screen-printing. Also, the inks used in this process can be simplified due to the high temperature and pressure ink delivery capability. Each screening ink contains appropriate amounts of nitrocellulose, glycerol, and isopropyl alcohol, resulting in a proper rheology for screen printing each type of layer: the aluminum electrode, the alumina-coated composition-modified barium titanate ceramic powder immersed in the poly(ethylene terephthalate) plastic dielectric, and the poly(ethylene terephthalate) plastic dielectric by itself. The number of these layers can vary depending on the electrical energy storage requirements. Each layer is dried; the binder burned out, and sintered before the next layer is screen-printed. Each aluminum electrode layer 12 is alternately offset to each of two opposite sides of the component automatically during this process as indicated in FIG. 2. These layers are screen-printed on top of one another in a continuous manner. When the specified number of layers is achieved, the array is cut into individual components to the specified sizes. In the example, the size is length=0.508 cm and the width 1.143 cm with an area=0.581 cm², however, these sizes can be varied as desired.

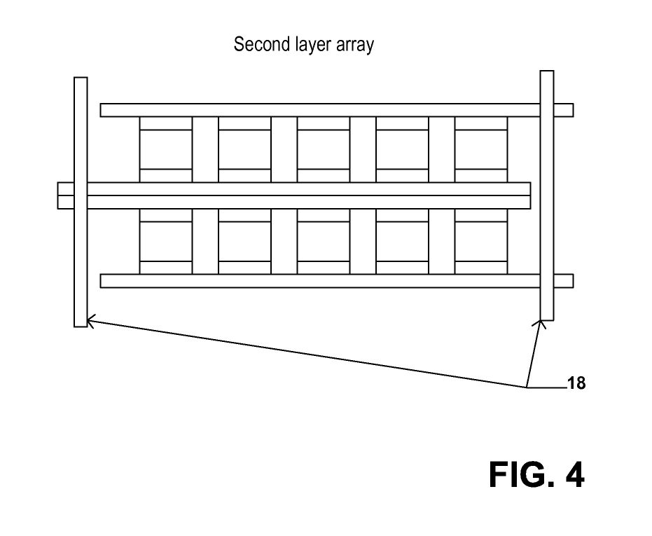

After each screen-printing operation in which a green sheet is fabricated having either 1 μm for the final thickness of the aluminum layers or 9.732 μm for the final thickness of the dielectric layer, or final thicknesses for the aluminum and dielectric layers that are suitable for the particular application, a drying, binder-burnout, and sintering operation is completed. The oven has multiple temperature zones that range from approximately 40° C. to 125° C. and the green sheets are passed through these zones at a rate that avoids cracking and delamination of the body. After this process is completed, the components are then properly prepared for the hot isostatic pressing (HIP) at approximately 180° C. and approximately 100 bar pressure. The HIP processing time is in the area of 45 minutes which includes a 10 minute temperature ramp time and a 5 minute cool down time. The ramp and cool down times can be either shorter or longer as desired. This process eliminates voids. After this process, the components are then abrasively cleaned on the connection side to expose the alternately offset interleaved aluminum electrodes 12. Then, aluminum end caps 14 are bonded onto each end component 15 that has the aluminum electrodes exposed with the use of a silver-filled epoxy resin as the adhesive. The components are then cured at 100° C. for 10 minutes to bond the aluminum end caps to the components as indicated in FIG. 3. This process can be varied to meet the epoxy processing requirements. The next step involves polarizing the components. As many as 6000 components are held in a tool or in the area of this amount. This holding tool is then placed into a fixture that retains the components between anode and cathode plates. Each anode and cathode is spring-loaded to ensure electrical contact with each component. The fixture is then placed into an oven where the processing temperature is increased to approximately 180° C. over a period of approximately 20 minutes. At the temperature of 180° C., voltages of −2000 V is applied to the cathode plates and +2000 V is applied to the anode plates, or voltages selected for the particular dielectric thickness, for a period of 5 minutes. These processing parameters can be varied to meet the processing requirement of the end cap processing step. At the completion of this process the alumina-coated composition-modified barium titanate powder immersed within the poly(ethylene terephthalate) plastic matrix is fully polarized or has a high level of polarization. The components are then assembled into a first-level array, FIG. 3, with the use of the proper tooling. The aluminum end caps are bonded onto the copper plates with silver filled epoxy resin. Then the first-level arrays are assembled into a second-level array, FIG. 4, by stacking the first array layers on top of one another in a preferential mode. This process is continued until sufficient numbers of arrays are stacked to obtain the desired energy storage for the particular EESU that is being produced. Then copper bars 18 are attached on each side of the arrays as indicated in FIG. 4. Then the EESU is packaged into its final assembly.

The features of this invention indicate that the EESU, as indicated in Table 1, outperforms the electrochemical battery in every parameter. This technology provides mission-critical capability to many sections of the energy-storage industry.

TABLE 1

| | EESU | NiMH | LA(Gel) | Ni—Z | Li-Ion |
|---|---|---|---|---|---|
| Weight | 286.56 | 1716 | 3646 | 1920 | 752 |
| (pounds) | | | | | |
| Volume (inch³) | 4541 | 17,881 | 43,045 | 34,780 | 5697 |
| Discharge rate/ | 0.1% | 5% | 1% | 1% | 1% |
| 30 days | | | | | |
| Charging time | *3-6 min | 1.5 hr | 8.0 hr | 1.5 hr | 6.0 hr |
| (full) | | | | | |
| Life reduced | None | Moderate | High | Moderate | High |
| with deep | | | | | |
| cycle use | | | | | |
| Hazardous | None | Yes | Yes | Yes | Yes |
| materials | | | | | |

*The charging time is restricted by the converter circuits not the EESU.

The parameters of each technology to store 52.22 kWh of electrical energy are indicated—(data from manufacturers' specification sheets). The EESU data in this chart was taken from test samples and can have a certain degree of variability either up or down in value.

This EESU has the potential to revolutionize the electric vehicle (EV) industry, provide effective power averaging for the utility grids, the storage and use of electrical energy generated from alternative sources with the present utility grid system as a backup source for residential, commercial, and industrial sites, or the electric energy point of sales to EVs, or provide mission-critical power storage for many military programs. The EESU may replace the electrochemical battery in any of the applications that are associated with the above business areas.

FIGS. 1, 2, 3, and 4 of the drawings and the following description depict various preferred embodiments of the present invention for purposes of illustration only. One skilled in the art will readily recognize from the following discussion that those alternative embodiments of the structures and methods illustrated herein may be employed without departing from the principles of the invention described herein. While the invention will be described in conjunction with the preferred embodiments, it will be understood that they are not intended to limit the invention to those embodiments. On the contrary, the invention is intended to cover alternatives, modifications, and equivalents, which may be included within the spirit and scope of the invention as defined by the claims.

The screen printing of the alumina-coated composition-modified barium titanate powder and poly(ethylene terephthalate) plastic powder mixture as an ink works well when the particle sizes of these two components are nearly the same. In the example, the average particle size is 0.64 μm. This average particle size can be either smaller or larger depending of the powder processing techniques. Since the poly(ethylene terephthalate) plastic is generally not available in powder form, but often only as pellets, these pellets are pulverized to submicron-sized powder. The plastic being relatively soft is cryogenically embrittled so that it will fragment by impact shattering. On the other hand, the temperature/pressure mini extrusion multilaying technique processes the PET or other thermoplastic material utilized in the production of components in a melted condition.

Similarly, aluminum powder is available at economical pricing in particle sizes that are too large for this application. However, in the same way as described for the poly(ethylene terephthalate) (PET) plastic pellets, aluminum being a relatively soft metal, its powder can be embrittled cryogenically and then fragmented by impact shattering. Here again, in the temperature/pressure mini extrusion multilayering technique, the metal utilized in the production of components can be processed in a melted condition.

Systems to accomplish this task have been developed for cryogenic freezing of the plastic pellets and the aluminum powders, e.g., the Air Products Process Cooling System, and for impact jet pulverizing of these cryogenic-frozen pellets and the aluminum powder: the Micron-Master jet mill manufactured by The Jet Pulverizer Company.

The binder for the screen-printing ink includes the low-decomposition-temperature resin: nitrocellulose and two solvents for the resin: glycerol and isopropyl alcohol, the former being more viscous than the latter, so that the proper screen-printing rheology can be easily adjusted.

Three screen-printing inks are utilized:

1. poly(ethylene terephthalate) plastic powder, alumina-coated composition-modified barium titanate ceramic powder, and the binder.

2. poly(ethylene terephthalate) plastic powder and the binder

3. aluminum metal powder and the binder

For the case of the first screen-printing ink with respect to the volume ratio of the plastic powder to the ceramic powder, this ratio can range from 35/65 to 6/94. The high-relative-permittivity dielectric layers are formed from this ink with final thicknesses after hot isostatic pressing ranging from 5 to 20 μm. However, wider ranges as indicated above can be utilized depending of the application. With the second screen-printing ink, the surrounding low-relative-permittivity dielectric layers are formed of equal final thickness to the high-relative-permittivity layers or the aluminum electrode layers. The purpose of these layers is to avoid electric-field fringing at the edges of the high-relative-permittivity layers. With the third screen-printing ink, the aluminum electrodes are formed with final thickness after hot isostatic pressing ranging from 1 to 2 μm. However a wider range as indicated can be utilized depending of the application.

The screen-printing of the materials for the multilayer capacitor array encourages that the plastic, ceramic, and metal powders be of comparable particle size. Since the ceramic powder is in-situ coprecipitated from aqueous solution as submicron in size, commercially available poly(ethylene terephthalate) plastic pellets and aluminum powder are reduced in size. These relatively soft materials are cooled to cryogenic temperatures to enable embrittlement to occur. Then, by jet impact of the chilled materials, shattering occurs. With several passes of the chilled material through the jet pulverizer the particles are reduced to submicron size.

The chilling of the material is carried out in a cryogenic cooling conveyer that cools the poly(ethylene terephthalate) plastic pellets to in the area of −150° C. This conveyer is then the feeder of the chilled material to the air jet pulverizer.

A basis layer of the plastic powder and binder is screen-printed onto a flat Teflon® polytetrafluoroethylene plastic-coated (or alternative coating, if any) stainless steel plate, this first layer serving as a substrate and dielectric layer isolating the next aluminum electrode layer from contact with the outside. The Teflon® plastic coating on the stainless steel plates keeps the elements from sticking to the plate surface during the heat treatment of the green sheets after each screen-printing step.

The next layer comprising aluminum powder and binder is screen-printed onto the first layer with a stencil, this second layer serving as the electrode and offset to one end of the dielectric layer.

As part of the second layer and surrounding the electrodes layer on three of its sides, a layer of plastic powder and binder is screen-printed with a stencil onto the first layer.

A third layer of plastic powder, ceramic powder, and binder is screen-printed onto the second layer with a stencil, this third layer serving as the active dielectric layer.

As part of the third layer and surrounding the active dielectric layer on all four of its sides, a layer of plastic powder and binder is screen-printed with a stencil onto the second layer.

A fourth layer of aluminum powder and binder is screen-printed with a stencil onto the third layer, this fourth layer serving as the opposite electrode to the active dielectric layer and offset to the opposite end of the dielectric layer.

As part of the fourth layer and surrounding the electrode layer on three of its sides, a layer of plastic powder and binder is screen-printed with a stencil onto the third layer.

This collection of steps except the first step is repeated any number of times, anywhere from one to a thousand. Arrays of 100 dielectric and electrode layers are used to produce elements for the proof-of-concepts development. In this fashion the multilayer array is built up. The number of dielectric layers can be varied to meet the particular application.

The last concluding step is a repeat of the first step.

After each screen-printing step the Teflon® plastic-coated stainless steel plate containing the just-deposited green sheet is processed by an inline oven. This oven provides two functions with the first being binder burnout and the second being the sintering and densification to the closed pore porous condition. This oven has multiple heating zones with the first zone at temperature of 40° C. and the last zone at temperature of 150° C. The time for the elements to be processed through these zones depends on the thickness of the green layer, but is in the range of 10 seconds for the electrode layers and 60 seconds for the dielectric layers for the elements fabricated for the example of this invention. The processing time is selected to ensure that the green layers do not destructively crack and rupture. The processing times and temperatures indicated above can be varied to meet the processing requirement for different final products or different materials.

The screen-printed sheets of the multilayer elements are diced into individual elements. The elements dimensions are approximately 0.508 cm by 1.143 cm.

The elements are then placed into the indentations of Teflon® plastic-coated stainless steel trays. The trays have the capability to hold approximately 6,000 elements. The Teflon® plastic coating prevents the elements from sticking to the stainless steel tray. The trays containing the elements are then inserted into a hot isostatic pressing (HIP) oven capable of 100 bar pressure with clean dry air and 180° C. temperature is employed. The processing time of this HIP process is 45 minutes, which includes a 10 minute temperature ramp up time and a 5 minute cooldown time. The processing times and temperatures indicated above can be varied to meet the processing requirement for different final products or different materials.

Then ten elements are then bonded together with an adhesive having a curing temperature of 80° C. for duration of 10 minutes. These temperatures and times can be varied to meet the requirements of the material in use. Also, the components can be fabricated by printing the amount of dielectric layers required such as 1000 more or less.

After completion of the bonding step the aluminum electrode layers at two opposite ends of the multilayer array are connected to one another of the same side after these sides have been abrasively cleaned to expose the aluminum electrodes. A high-conductivity silver-loaded epoxy resin paste with elastomeric characteristic (mechanical shock absorption) is selected to connect the aluminum electrode layers of the multilayer array to the aluminum end caps for attachment by silver-filled epoxy resin or whatever end cap attachment method necessary for the different applications.

The completed multilayer components are poled by applying a polarizing electric field across each of the active dielectric layers. Since there layers are electrically parallel within each multilayer array and that these multilayer arrays can be connected in parallel, the applied voltage to accomplish the polarizing electric field can be as high as the working voltage. The components are heated in an oven to at least 180° C. before the polarizing voltage is applied. A temperature of 180° C. and applied voltages of +2000 V and −2000 V for duration of 5 minutes are utilized in the example of this invention. The processing times, temperatures, and voltage indicated above can be varied to meet the processing requirement for different final products or different materials.

### Ink Slurry Mixer and Disperser

The ink slurry mixer and disperser is comprised of a polyethylene plastic or polypropylene plastic tank, a Teflon® polytetrafluoroethylene-plastic-coated stainless steel paddle mixer, ultrasonic agitation, and multiple recirculating peristaltic pumps with the associated tubing. The slurry as multiple streams are recirculated from the tank bottom and at the tank top reintroduced with the multiple streams oppositely directed toward on another. This high impact of the powders in these multiple streams will ensure that any retained charges are released, thus providing a well-dispersed ink free of agglomerates suitable for screen printing.

### Ink Delivery to the Screen Printer

Each of the three screen-printing inks is delivered to the appropriate stations of the screen-printing system. Peristaltic pumps with their associated plastic tubing are used to convey the inks from the polyethylene plastic or polypropylene plastic tanks employed for ink making to a line manifold with several equal-spaced holes located at one edge of each printing screen, so as to distribute the ink uniformly at this edge. Higher pressure peristaltic pumps are used so that essentially all the pressure drop occurs at the manifold hole exits.

The ink mixing, dispensing, and delivery in the high temperature/pressure mini extrusion multilayering technique is accomplished with the use of pressure tanks at the acceptable temperature and pressures and valves activated at the correct processing times.

### EXAMPLE

The electrical-energy-storage unit's weight, stored energy, volume, and configuration design parameters.
The relative permittivity of the high-permittivity powder to be achieved is 21,072.
   The 100 Å coating of Al₂O₃ and 100 Å of poly(ethylene terephthalate plastic reduce the relative permittivity by 12%.
   The resulting K=18,543
Energy stored by a capacitor: E=CV²/(2×3600 s/h)=W·h
   C=capacitance in farads (F)
   V=voltage across the terminals of the capacitor
   It is estimated that is takes 14 hp, 746 W per hp, to power an electric vehicle running at 60 mph with the lights, radio, and air conditioning on. The energy-storage unit must supply 52,220 W·h or 10,444 W for 5 hours to sustain this speed and energy usage and during this period the EV will have traveled 300 miles.
   Design parameter for energy storage—W=52.22 kWh
   Design parameter for working voltage—V=3500 V
   Resulting design parameter of capacitance—C=30.693 F

C=∈₀KA/t
∈₀=permittivity of free space
K=relative permittivity of the material
A=area of the energy-storage component layers
t=thickness of the energy-storage component layers

Test data of materials, layers, cells, elements, developed components, and the final EESU.
The area of the element, which has 100 cells (capacitors) screen-printed layers, is as follows:
   Area=0.508 cm×1.143 cm=0.5806 cm²
The resulting design parameter for dielectric layer thickness—t=9.732×10⁻⁴ cm
   Volume of the dielectric layer=0.5806 cm²×9.732×10⁻⁴ cm=0.0005651 cm³
   Weight of the alumina-coated composition-modified barium titanate powder=(0.0005651 cm³×1000×31,351×6.5 g/cm³×0.94)=238.43 pounds
   Weight of the poly(ethylene terephthalate) powder=(0.0005651 cm³×1000×31,351×1.4 g/cm³×0.04)=2.185 pounds
The electrode layer thickness=1 μm
   Volume of the electrode=0.5806 cm²×1 μm=5.806×10⁻⁵ cm³
   Weight of the aluminum powder=(5.806×10⁻⁵ cm³×1010×31,351×2.7 g/cm³)=10.93 pounds
Total weight of the EESU including the box, connectors, and associated hardware
   Wt=281.56 pounds
Capacitance of one component=(8.854×10⁻¹² F/m×1.8543×10⁴×5.806×10⁻⁵ m²/9.73×10⁻⁶ m)×10 elements×100 cells=0.000979 F
Number of components required to store 52.22 kWh of electrical energy:
   Nc=30.693 F/0.000979 F=31,351.379 31,351

The above data can be varied to meet the requirements of different applications.

The following data indicates the results of pulverizing the poly(ethylene terephthalate) plastic pellets.

| % Volume | Size in μm |
|---|---|
| 0.25 | 0.2 |
| 0.35 | 0.3 |
| 2.1 | 0.4 |
| 15 | 0.5 |
| 58.55 | 0.6 |
| 16 | 0.7 |
| 5 | 0.8 |
| 0.25 | 1 |

Average size of the PET plastic powder is 0.64 μm.

The following data indicates the results of the pulverizing of the aluminum powder

| % Volume | Size in μm |
|---|---|
| 0.12 | 0.05 |
| 0.7 | 0.07 |
| 2.5 | 1.2 |
| 17 | 1.9 |
| 59.5 | 2.3 |
| 16 | 2.9 |
| 3.1 | 3.4 |
| 0.41 | 3.9 |

Average aluminum particle size=2.4 μm

The following data indicates the relativity permittivity of ten single-coated composition-modified barium titanate powder batches.

| | Relative Permittivity |
|---|---|
| Batches | @ 85° C. |
| 1 | 19,901 |
| 2 | 19,889 |
| 3 | 19,878 |
| 4 | 19,867 |
| 5 | 19,834 |
| 6 | 19,855 |
| 7 | 19,873 |
| 8 | 19,856 |
| 9 | 19,845 |
| 10 | 19,809 |

Average relativity permittivity = 19,861

This level of relative permittivity results from the exemplary process described herein. However, components of other relative permittivity may be used.

The following data indicates the relativity permittivity of ten components measured at 85° C., then 85° C. and 3500 V, and the last test 85° C. and 5000 V.

| | | 85° C. | 85° C. |
|---|---|---|---|
| Components | 85° C. | (−3500 V) | (−5000 V) |
| 1 | 19,871 | 19,841 | 19,820 |
| 2 | 19,895 | 19,866 | 19,848 |
| 3 | 19,868 | 19,835 | 19,815 |
| 4 | 19,845 | 19,818 | 19,801 |
| 5 | 19,881 | 19,849 | 19,827 |
| 6 | 19,856 | 19,828 | 19,806 |
| 7 | 19,874 | 19,832 | 19,821 |
| 8 | 19,869 | 19,836 | 19,824 |
| 9 | 19,854 | 19,824 | 19,808 |
| 10 | 19,877 | 19,841 | 19,814 |
| Avg. K | 19,869 | 19,837 | 19,818 |

Results indicate that the composition-modified barium titanate powder that has been coated with approximately 100 Å of Al₂O₃, immersed into a matrix of PET plastic or other acceptable plastics or materials, and has been polarized provides a dielectric saturation that is above the 5000 V limit or in the range of this value and the relative permittivity is highly insensitive to both voltage and temperature.

Leakage current of ten EESUs that contain 31,351 components each and having the capability of storing 52.22 kWh of electrical energy is measured at 85° C. and 3500 V.

| EESU | Leakage Current - μA |
|---|---|
| 1 | 4.22 |
| 2 | 4.13 |
| 3 | 4.34 |
| 4 | 4.46 |
| 5 | 4.18 |
| 6 | 4.25 |
| 7 | 4.31 |
| 8 | 4.48 |
| 9 | 4.22 |
| 10 | 4.35 |
| Avg. | 4.28 |

Voltage breakdown of ten components with and average dielectric thickness of 9.81 μm is measured at a temperature of 85° C.

| Component | Voltage Breakdown - 10⁶ V/cm |
|---|---|
| 1 | 5.48 |
| 2 | 5.75 |
| 3 | 5.39 |
| 4 | 5.44 |
| 5 | 5.36 |
| 6 | 5.63 |
| 7 | 5.77 |
| 8 | 5.37 |
| 9 | 5.64 |
| 10 | 5.88 |
| Avg. | 5.57 |

Full charge/discharge cycles of a component is from 3500 V to 0 V at 85° C. After each 100,000 cycles the leakage current is recorded. The leakage current is multiplied by 31,351 to reflect the full EESU value. The rise time on the charging voltage is 0.5 seconds and the discharge time is 1.0 seconds. The RC time constant is 0.11 seconds for both the charging and the discharging times. The voltage breakdown is tested at the end of 106 cycles and is measured at 85° C. with the results being 5.82×10⁶ V/cm and the total capacitance is measured at 30.85 F. The final test data indicates that the full cycle testing does not degrade the total capacitance, leakage, or voltage breakdown capabilities of the component.

| Test Cycle | Leakage Current - μA |
|---|---|
| 1 | 4.29 |
| 2 | 4.28 |
| 3 | 4.21 |
| 4 | 4.38 |
| 5 | 4.30 |
| 6 | 4.42 |
| 7 | 4.31 |
| 8 | 4.26 |
| 9 | 4.46 |
| 10 | 4.41 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An electrical storage unit comprising a plurality of sets of layers, each set of layers comprising:
a first layer comprising a first electrode and plastic surrounding the first electrode on three sides of the first electrode within the first layer;
a second layer comprising a first active dielectric and plastic surrounding the first active dielectric on all four sides of the first active dielectric within the second layer;
a third layer comprising a second electrode and plastic surrounding the second electrode on three sides of the second electrode within the third layer; and
a fourth layer comprising a second active dielectric and plastic surrounding the second active dielectric on all four sides of the second active dielectric within the fourth layer.

2. The electrical storage unit of claim 1, wherein the first electrode is offset to one end of the first layer.

3. The electrical storage unit of claim 2, wherein the second electrode is offset to an opposite end relative to the one end.

4. The electrical storage unit of claim 1, wherein the first electrodes of the repeated sets of layers are connected to one another.

5. The electrical storage unit of claim 1, wherein the second electrodes of the repeated sets of layers are connected to one another.

6. The electrical storage unit of claim 1, wherein the first and second active dielectrics are polarized.

7. The electrical storage unit of claim 1, wherein the plastic comprises polyethylene terephthalate.

8. An electrical storage unit comprising:
a plurality of sets of layers, each set of layers comprising:
a first layer comprising a first electrode and plastic surrounding the first electrode on three sides of the first electrode within the first layer, the first electrode offset to one end of the first layer;
a second layer comprising a first active dielectric and plastic surrounding the first active dielectric on all four sides of the first active dielectric within the second layer;
a third layer comprising a second electrode and plastic surrounding the second electrode on three sides of the second electrode within the third layer, the second electrode offset to an opposite end relative to the one end; and
a fourth layer comprising a second active dielectric and plastic surrounding the second active dielectric on all four sides of the second active dielectric within the fourth layer; and
the first electrodes of the repeated sets of layers being connected to one another;
the second electrodes of the repeated sets of layers being connected to one another; and
the first and second active dielectrics being polarized.

9. A method of forming an electrical energy storage unit, the method comprising:
a. printing plastic as part of a first layer;
b. printing, onto the first layer, a second layer including metal to serve as a first electrode;
c. printing, surrounding on three sides of the first electrode, plastic as part of the second layer;
d. printing, onto the second layer and as part of a third layer, an active dielectric layer including plastic and a ceramic powder;
e. printing plastic as part of the third layer and surrounding the active dielectric layer on four sides;
f. printing, onto the third layer, a fourth layer including metal to serve as a second electrode; and
g. printing plastic as part of the fourth layer and surrounding the second electrode on three sides.

10. The method of claim 9, further comprising processing the first, second, and third layers in an inline oven having multiple heating zones after each printing step.

11. The method of claim 9, further comprising repeating steps b through g to form an element.

12. The method of claim 11, further comprising hot isostatically pressing the element.

13. The method of claim 12, further comprising bonding the element to another element with an adhesive.

14. The method of claim 13, further comprising:
heating the elements after connecting; and
applying a polarizing electric field across the active dielectric layer.

15. The method of claim 9, wherein printing the second layer includes printing the first electrode offset to one end relative to the first layer.

16. The method of claim 15, wherein printing the fourth layer includes printing the second electrode offset to an opposite end relative to the one end.

17. The method of claim 15, connecting the first electrode and other electrodes located on the one end after abrasively cleaning to expose the electrodes.

18. The method of claim 9, wherein printing includes screen-printing.

19. The method of claim 18, wherein screen-printing includes screen-printing with a stencil.

20. The method of claim 9, wherein the plastic comprises polyethylene terephthalate.

21. The method of claim 9, wherein printing plastic includes printing an ink including plastic powder dispersed within the ink.

22. The method of claim 9, wherein printing metal includes printing an ink including the metal and a binder.

23. The method of claim 9, wherein printing plastic and the ceramic powder includes printing an ink including plastic powder and the ceramic powder.
